(19) United States
(12) Patent Application Publication
(10) Pub. No.: US 2012/0171486 A1
(43) Pub. Date: Jul. 5, 2012

(54) Biosoluble inorganic fiber

(75) Inventors: Hideki Kitahara, Tokyo (JP); Takahito Mochida, Tokyo (JP); Takashi Nakajima, Tokyo (JP)

(73) Assignee: Nichias Corporation, Tokyo (JP)

(21) Appl. No.: 12/929,089

(22) Filed: Dec. 29, 2010

(51) Int. Cl. C09K 21/02

(52) U.S. Cl. 428/401; 252/601

(57) ABSTRACT

An inorganic fiber having the following composition: 71 wt % to 80 wt % of SiO₂, 18 wt % to 27 wt % of CaO, 0 to 3 wt % of MgO, and 1.1 wt % to 3.4 wt % of Al₂O₃, with the proviso that each amount of ZrO₂, alkali metal oxides, La₂O₃, TiO₂, ZnO, B₂O₃ and P₂O₅ is 0.1 wt % or less, and the total amount of SiO₂, CaO, MgO and Al₂O₃ is 99 wt % or more.

### BACKGROUND OF THE INVENTION

1. Field of the Invention

The invention relates to an alkaline earth silicate fiber which is soluble in a physiological saline.

2. Description of the Related Art

Inorganic fibers are light-weight, easily treatable, and excellent in heat resistance, and hence, for example, they are used as heat-resistant sealing materials. On the other hand, in recent years, it has been indicated that the inorganic fibers are inhaled into human bodies to invade the lungs. Thus, there have been developed biosoluble inorganic fibers which do not or scarcely bring about the above problem even if inhaled into the human bodies (e.g., Patent Documents 1 and 2).
Patent Document 1: Japanese Patent Publication No. 3753416
Patent Document 2: Japanese PCT Patent Application Laid-open No. 2005-514318

Patent Document 2 discloses many fibers which are excellent in fire resistance and physiological solubility, but the quality of the fibers is poor. In particular, it is described therein that the more the amount of Al₂O₃ is, the lower the physiological solubility is, and this fact adversely affects the quality of the fibers.

With regard to inorganic fibers which are soluble in a physiological fluid, the viscosity of their raw materials is high, and hence the materials have to be heated up to an extremely high temperature for fiber spinning. Therefore, it has been difficult to obtain the fibers having a small fiber diameter.

In addition, there is another problem that when the water solubility of the fibers is high, molding is difficult.

### SUMMARY OF THE INVENTION

An object of the invention is to provide an inorganic fiber which has fire resistance and physiological solubility and is easily manufactured and processed.

The inventors of the invention have intensively investigated, and as a result, it has been found that a fiber of a specific composition has extremely excellent properties. That is, the fiber of the specific composition is excellent in physiological solubility before and after heating, and a fiber quality, and the viscosity of a material to be used is low, which makes fiber spinning easy. In addition, water solubility of the fiber is not too high, which makes molding and manufacturing easy. On the basis of the finding, the invention has been completed.

According to the invention, the following inorganic fibers can be provided.

1. An inorganic fiber having the following composition:

SiO₂ about 71 wt % to about 80 wt %

CaO about 18 wt % to about 27 wt %

MgO 0 to about 3 wt %

Al₂O₃ about 1.1 wt % to about 3.4 wt %

with the proviso that each amount of ZrO₂, alkali metal oxides, La₂O₃, TiO₂, ZnO, B₂O₃ and P₂O₅ is 0.1 wt % or less, and the total amount of SiO₂, CaO, MgO and Al₂O₃ is about 99 wt % or more.

2. The inorganic fiber according to the above 1, having the following composition:

SiO₂ about 71 wt % to about 77 wt %

CaO about 20 wt % to about 27 wt %

MgO 0 to about 3 wt %

Al₂O₃ about 1.1 wt % to about 3.4 wt %

with the proviso that each amount of ZrO₂, alkali metal oxides, La₂O₃, TiO₂, ZnO, B₂O₃ and P₂O₅ is 0.1 wt % or less, and

the total amount of SiO₂, CaO, MgO and Al₂O₃ is about 99 wt % or more.

3. The inorganic fiber according to the above 2, having the following composition:

SiO₂ about 71 wt % to about 76 wt %

CaO about 21 wt % to about 26 wt %

MgO 0 to about 3 wt %

Al₂O₃ about 1.1 wt % to about 3.4 wt %

with the proviso that each amount of ZrO₂, alkali metal oxides, La₂O₃, TiO₂, ZnO, B₂O₃ and P₂O₅ is 0.1 wt % or less, and

the total amount of SiO₂, CaO, MgO and Al₂O₃ is about 99 wt % or more.

4. The inorganic fiber according to any one of the above 1 to 3, wherein the amount of Al₂O₃ is about 1.1 wt % to about 1.95 wt %.

5. The inorganic fiber according to any one of the above 1 to 3, wherein the amount of Al₂O₃ is about 2.0 wt % to about 3.4 wt %.

6. The inorganic fiber according to any one of the above 1 to 3, wherein the amount of Al₂O₃ is about 1.3 wt % to about 2.5 wt %.

7. The inorganic fiber according to any one of the above 1 to 6, wherein the amount of SiO₂ is about 71.25 wt % or more.

8. The inorganic fiber according to any one of the above 1 to 7, of which the average fiber diameter is about 2 μm to about 6 μm.

9. The inorganic fiber according to the above 8, of which the average fiber diameter is about 2 μm to about 4 μm.

10. A manufacturing method of the inorganic fiber according to any one of the above 1 to 9 which comprises preparing a melt containing SiO₂, CaO, MgO and Al₂O₃, and then forming the melt into fibers.

According to the invention, fibers which enables easy manufacturing of secondary products can be provided, because the fibers have physiological solubility even after heating, and ingredients thereof are not excessively solved out even during the manufacturing of the secondary products.

### BRIEF DESCRIPTION OF THE DRAWINGS

FIG. 1 shows relations between temperatures and viscosities of fibers in Example 1 and Comparative Example 1.

### DETAILED DESCRIPTION OF THE INVENTION

A fiber of the invention has the following composition:

SiO₂ 71 wt % to 80 wt %

CaO 18 wt % to 27 wt %

MgO 0 to 3 w %

Al₂O₃ 1.1 wt % to 3.4 wt %

Usually, the fiber of the invention does not contain ZrO₂. The amount of ZrO₂ is 0.1 wt % or less, or less than 0.1 wt %.

Usually, the fiber of the invention does not contain La₂O₃. The amount of La₂O₃ is 0.1 wt % or less, or less than 0.1 wt %.

K₂O may or may not be contained, and the amount of K₂O is 0.2 wt % or less, 0.15 wt % or less, or 0.1 wt % or less. K₂O may be contained in an amount of more than 0.01 wt %, 0.05 wt % or more, or 0.08 wt % or more.

Usually, the fiber of the invention does not contain Na₂O, Na₂O may or may not be contained, and the amount of Na₂O is 0.2 wt % or less, 0.15 wt % or less, or 0.1 wt % or less. Na₂O may be contained in an amount of more than 0.01 wt %, 0.05 wt % or more, or 0.08 wt % or more.

Usually, the fiber of the invention does not contain TiO₂. In addition, each of ZnO, B₂O₃, P₂O₅ and SrO is not contained. In a certain case, each of SrO and P₂O₅ is contained in an amount of 0.1 wt % or less, or less than 0.1 wt %.

Fe₂O₃ may be contained in an amount of 0.1 to 0.3 wt %.

The total amount of SiO₂, CaO, MgO and Al₂O₃ is 99 wt % or more, and can be 99.5 wt % or more, or 99.7 wt % or more.

When Fe₂O₃ is contained, the total amount of SiO₂, CaO, MgO, Al₂O₃ and Fe₂O₃ may be 99.7 wt % or more, 99.8 wt % or more, 99.9 wt % or more, or 100 wt %.

When the amount of SiO₂ is 71 to 80 wt %, the produced fiber is excellent in heat resistance. When SiO₂ is too much, the production of cristobalite, which is produced after heating and is a carcinogenic substance, might increase. Therefore, the amount of SiO₂ is preferably 71 to 77 wt %, and more preferably 71 to 76 wt %.

When the amount of CaO is 18 to 27 wt %, the produced fiber has excellent biosolubility and high tensile strength. The amount of CaO is preferably 20 to 27 wt %, and more preferably 21 to 26 wt %.

When the amount of MgO is 0 to 3 wt %, the produced fiber is excellent in biosolubility. When MgO is too much, the biosolubility after heating might deteriorate. The amount of MgO is preferably 0 to 1 wt %. Usually, MgO is present in excess of 0 wt %.

When the amount of Al₂O₃ is 1.1 to 3.4 wt %, the produced fiber has suitable water solubility without impairing a fiber quality, so that the fiber can easily be processed. The amount of Al₂O₃ is preferably 1.3 to 3.0 wt %.

The amount of Al₂O₃ can be 1.3 to 1.95 wt %, or 1.4 to 1.7 wt %. Furthermore, the amount of Al₂O₃ can be 2 to 3 wt %.

The fibers of the invention having the above composition are excellent in biosolubility, and particularly after heating, the biosolubility is enhanced. The inorganic fibers of the invention are often used as insulating materials. Since the fibers before heating have the biosolubility, there be scarcely fear that the health of workers is impaired during manufacturing and installation. Since the fibers after heating have the biosolubility, there is scarcely fear that the health of workers is impaired during decomposition, and dismantlement after use under heating circumstance.

When the above-mentioned composition is employed, the good fibers having a high fiber quality can be obtained by a usual manufacturing method. Furthermore, a melt for producing the fiber of the invention has a low viscosity, and hence fine fibers can be produced at a low temperature. By spinning at a high temperature and at a high speed during manufacturing, a fiber diameter can be reduced. An average fiber diameter is usually 2 to 6 μm, and preferably 2 to 4 μm.

In the case of the fibers having a small fiber diameter, hand feeling is smooth, and prickly feeling does not occur. The fiber diameter being small means that the fibers easily dissolve in a physiological fluid and the number of fibers per unit volume of product increases, whereby the thermal conductivity of the product lowers and the heat insulation effect thereof is enhanced. In addition, when processing, the fibers having a small diameter enable the production of processed goods having a high density, and the goods thus processed can possess a high heat insulation effect. Furthermore, when a large number of fibers are present per unit volume, the obtained product has high tensile strength. Thus, the fibers of the reduced diameter have many advantages.

Moreover, the fibers of the invention include less kinds of essential ingredients, and hence the number of blending processes decreases, which leads to cost reduction. SiO₂ and CaO are inexpensive, but the other ingredients are expensive, which leads to cost increase. In addition, since kinds of ingredients whose amounts are to be finely regulated are limited, difficulty of manufacturing can be decreased.

The fiber of the invention can be manufactured by preparing a melt including SiO₂, CaO, MgO and Al₂O₃, and then forming the melt into fiber. For example, the fiber can be manufactured by a spinning method in which a molten material is pouring onto a wheel rotating at a high speed, thereby forming fiber, or a blowing method in which compressed air is applied to a molten material, thereby forming fiber.

### Example 1

A fiber of a composition shown in Table 1 was manufactured. The manufactured fiber had a fiber diameter of 3.3 μm, and good shape and appearance. In addition, the amount of flakes which were not formed into fiber was small. From this fiber, there could be manufactured formed articles such as bulks, blankets, blocks, molds, papers, felts and irregular-shaped materials (mastiches and casters), boards, which were manufactured by use of a solvent such as water, without excessively solving out ingredients.

A fiber diameter was measured by the following procedure.

The fibers were observed and photographed through an electron microscope, and then 400 or more fibers of the photographed fibers were measured. An average of all the measured values of the fibers was defined as an average fiber diameter.

### Comparative Example 1

A fiber of a composition shown in Table 1 was manufactured.

TABLE 1

| | | | Comparative |
|---|---|---|---|
| | | Example 1 | Example 1 |
| Fiber | SiO₂ | 73.1 | 76.2 |
| compo- | CaO | 24.8 | 4.0 |
| sition | MgO | 0.3 | 17.6 |
| (wt %) | Al₂O₃ | 1.6 | 1.8 |
| | Fe₂O₃ | 0.2 | 0.2 |
| | K₂O | 0.0 | 0.2 |
| | Na₂O | 0.0 | 0.0 |
| | ZrO₂ | 0.0 | 0.0 |
| | P₂O₅ | 0.0 | 0.0 |
| | B₂O₃ | 0.0 | 0.0 |
| | La₂O₃ | 0.0 | 0.0 |

| | | |
|---|---|---|
| Average | 3 26 μm | 4.06 μm |
| fiber diameter | | |

### Evaluation Example 1

With regard to the fibers obtained in Example 1 and Comparative Example 1, biosolubilities of fibers which were not heated and fibers which were heated at 800° C. to 1260° C. were measured in the following procedure.

Fibers were put on a membrane filter, and saline was then dropped onto the fibers by a micropump. A filtrate which was passed through the fibers and the filter was collected in a vessel. For collected filtrates after 24 hours and 48 hours, solved ingredients were quantitatively analyzed by an ICP emission spectroanalyzer, followed by calculating a solubility and a dissolution velocity constant. Elements measured were 4 elements of Si, Al, Ca and Mg which were main elements. The composition of the saline is shown in Table 2.

In evaluating the biosolubility of the fibers, an influence due to a difference of surface areas (≈fiber diameters) of the fibers occurs in the case that a simple solubility is used. Therefore, the evaluation was made by measuring the fiber diameter, and then converting the measured fiber diameter into the dissolution velocity constant (unit: ng/cm²·h) which is a solved amount per unit surface area and unit time.

The dissolution velocity constant every heating temperature is shown in Table 3. As shown in Table 3, in Comparative Example 1, the solubility into the saline noticeably decreases by heating at 1000° C. or more, whereas in Example 1, the solubility increases without such decrease. This is considered to be caused by a difference between kinds of crystals formed from constitutional ingredients by the heating of the fibers.

TABLE 2

| Reagent | Weight(g) |
|---|---|
| NaCl | 6.78 |
| NaH₂PO₄•2H₂O | 0.18 |
| NaHCO₃ | 2.27 |
| Na₃citrate•2H₂O | 0.06 |
| Glycine | 0.45 |
| NH₄Cl | 0.54 |
| H₂SO₄ | 0.05 |
| CaCl₂ | 0.02 |
| Water | 1 L |

TABLE 3

| | | Comparative |
|---|---|---|
| Heating Temperature | Example 1 | Example 1 |
| Not heated | 306 | 355 |
| 800° C. | 371 | 294 |
| 1000° C. | 1136 | 26 |
| 1100° C. | 1437 | 8 |
| 1260° C. | 2621 | — |

Unit: ng/cm² · h

### Evaluation Example 2

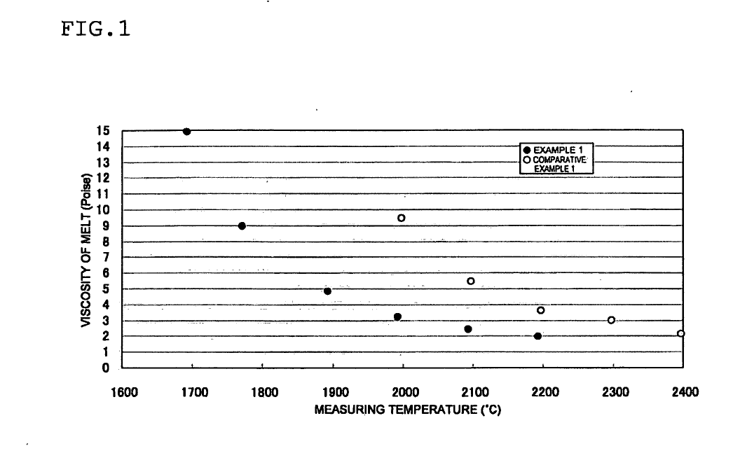

With respect to the fibers obtained in Example 1 and Comparative Example 1, relations between temperatures and viscosities were examined in an electric furnace capable of heating up to 2500° C. by use of a ball pull-up type viscosimeter. The results are shown in FIG. 1.

As shown in the drawing, a viscosity curve to the temperatures in Example 1 is more gradual than in Comparative Example 1. This fact indicates that for the fiber of Example 1, it is not necessary to raise a melting temperature, that is, the melting is possible with a low energy, and the melt can be extended at a higher speed owing to the low viscosity even at the same melting temperature. As a result, it is possible to reduce the fiber diameter.

### Evaluation Example 3

With respect to the fiber obtained in Example 1, the tensile strength of a blanket having a density of 128 kg/m³ and a thickness of 25 mm was measured. The results are shown in Table 4. In the same table, the results of tensile strengths of blankets described in Patent Document 2 (Japanese PCT Patent Application Laid-open No. 2005-514318) are also shown for comparison.

As shown in Table 4, the tensile strength of the fiber in Example 1 is equal to or higher than those of the examples of Patent Document 2 regardless of absence/presence of La. Particularly, in Patent Document 2, as an advantage of La₂O₃, there is described “It can be seen that the addition of only 1.3% La₂O₃ results in a considerable improvement in tensile strength, indicating a much improved fibre”. However, the fiber in Example 1 of the invention has, though La₂O₃ is not added thereto, the tensile strength equal to or higher than that of the fiber to which La₂O₃ is added.

TABLE 4

| | | Examples of JP-A-2005-514318 | |
|---|---|---|---|
| Oxides | Example 1 | No La | With La |
| Na₂O | <0.05 | <0.05 | 0.18 |
| MgO | 0.33 | 0.89 | 0.46 |
| Al₂O₃ | 1.55 | 0.64 | 0.66 |
| SiO₂ | 73.1 | 72.9 | 73.2 |
| K₂O | <0.05 | <0.05 | 0.08 |
| CaO | 24.8 | 25.5 | 23.6 |
| Fe₂O₃ | 0.22 | 0.11 | 0.14 |
| La₂O₃ | 0 | 0 | 1.3 |
| Tensile strength | 48-68 | 25-30 | 35-60 |

Unit of ingredient: wt %
Unit of tensile strength: kPa.

### Examples 2 to 12

Fibers of compositions shown in Table 5 were manufactured, and then evaluated. For measurement of a shrinkage caused by heating, blankets were manufactured, and volumes of the blankets before and after burning of at 1100° C. and 1260° C. for 24 hours were measured. Biosolubilities were measured in the same manner as in Evaluation Example 1.

TABLE 5

| | | | | | | | Heart Shrinkage | | |
|---|---|---|---|---|---|---|---|---|---|
| | Composition | | | | | | (%) | | Biosolubility |
| | (wt %) | | | | | | 1100° C. | 1260° C. | (ng/cm² · h) |
| | SiO₂ | CaO | MgO | Al₂O₃ | Fe₂O₃ | K₂O | 24 hours | 24 hours | Not heated |
| Example 2 | 72.8 | 23.1 | 0.3 | 3.4 | 0.2 | 0.1 | | | |
| Example 3 | 73.0 | 23.2 | 0.3 | 3.2 | 0.1 | 0.1 | | | |
| Example 4 | 73.2 | 23.2 | 0.3 | 3.0 | 0.2 | 0.1 | 0.89 | 4.43 | 36 |
| Example 5 | 73.2 | 23.6 | 0.3 | 2.7 | 0.1 | 0.0 | 0.67 | 2.90 | 72 |
| Example 6 | 72.8 | 24.1 | 0.3 | 2.5 | 0.1 | 0.1 | 0.57 | 2.34 | 136 |
| Example 7 | 72.9 | 24.4 | 0.3 | 2.3 | 0.2 | 0.0 | 0.61 | 2.21 | |
| Example 8 | 73.0 | 24.3 | 0.3 | 2.2 | 0.1 | 0.0 | | | |
| Example 9 | 73.0 | 24.6 | 0.3 | 2.0 | 0.2 | 0.1 | 0.64 | 2.23 | 201 |
| Example 10 | 72.2 | 25.3 | 0.3 | 1.9 | 0.1 | 0.1 | | | |
| Example 11 | 72.8 | 25.0 | 0.4 | 1.6 | 0.2 | 0.1 | | | |
| Example 12 | 72.5 | 25.4 | 0.4 | 1.5 | 0.1 | 0.1 | 0.89 | 2.77 | 317 |
| Example 13 | 72.6 | 25.5 | 0.3 | 1.3 | 0.1 | 0.1 | | | |
| Example 14 | 73.0 | 25.2 | 0.3 | 1.2 | 0.2 | 0.1 | | | |

The inorganic fibers of the invention can be used in various use applications as insulating materials and replacements for asbestos.

Although only some exemplary embodiments and/or examples of amount have been described in detail above, those skilled in the art will readily appreciate that many modifications are possible in the exemplary embodiments and/or examples without materially departing from the novel teachings and advantages of amount. Accordingly, all such modifications are intended to be included within the scope of amount.

The documents described in the specification are incorporated herein by reference in its entirety.

What is claimed is:

1. An inorganic fiber having the following composition:
SiO₂ 71 wt % to 80 wt %
CaO 18 wt % to 27 wt %
MgO 0 to 3 wt %
Al₂O₃ 1.1 wt % to 3.4 wt %
with the proviso that each amount of ZrO₂, alkali metal oxides, La₂O₃, TiO₂, ZnO, B₂O₃ and P₂O₅ is 0.1 wt % or less, and
the total amount of SiO₂, CaO, MgO and Al₂O₃ is 99 wt % or more.

2. The inorganic fiber according to claim 1 which has the following composition:
SiO₂ 71 wt % to 77 wt %
CaO 20 wt % to 27 wt %
MgO 0 to 3 wt %
Al₂O₃ 1.1 wt % to 3.4 wt %
with the proviso that each amount of ZrO₂, alkali metal oxides, La₂O₃, TiO₂, ZnO, B₂O₃ and P₂O₅ is 0.1 wt % or less, and
the total amount of SiO₂, CaO, MgO and Al₂O₃ is 99 wt % or more.

3. The inorganic fiber according to claim 2 which has the following composition:
SiO₂ 71 wt % to 76 wt %
CaO 21 wt % to 26 wt %
MgO 0 to 3 wt %
Al₂O₃ 1.1 wt % to 3.4 wt %
with the proviso that each amount of ZrO₂, alkali metal oxides, La₂O₃, TiO₂, ZnO, B₂O₃ and P₂O₅ is 0.1 wt % or less, and
the total amount of SiO₂, CaO, MgO and Al₂O₃ is 99 wt % or more.

4. The inorganic fiber according to claim 1, wherein the amount of Al₂O₃ is 1.1 wt % to 1.95 wt %.

5. The inorganic fiber according to claim 1, wherein the amount of Al₂O₃ is 2.0 wt % to 3.4 wt %.

6. The inorganic fiber according to claim 1, wherein the amount of Al₂O₃ is 1.3 wt % to 2.5 wt %.

7. The inorganic fiber according to claim 1, wherein the amount of SiO₂ is 71.25 wt % or more.

8. The inorganic fiber according to claim 1 which has an average fiber diameter is 2 μm to 6 μm.

9. The inorganic fiber according to claim 8 which has an average fiber diameter of 2 μm to 4 μm.

10. A manufacturing method of the inorganic fiber according to claim 1 which comprises preparing a melt containing SiO₂, CaO, MgO and Al₂O₃, and forming the melt into fiber.
